(19) United States
(12) Patent Application Publication
(10) Pub. No.: US 2026/0125974 A1
(43) Pub. Date: May 7, 2026

(54) PASSIVE COOLING SYSTEM FOR A POST-COMBUSTION CARBON CAPTURE UNIT PROVIDING WATER MAKE-UP INTEGRATED WITH A SHALE OIL PRODUCTION AND NATURAL GAS COMPRESSOR STATION OPERATION

(71) Applicant: PETRONAS Energy Canada Ltd., Calgary (CA)

(72) Inventors: Ian BUCHANAN, Calgary (CA); Darius REMESAT, Calgary (CA); David DENTON, Calgary (CA); Derrick BAKUSKA, Calgary (CA)

(21) Appl. No.: 18/938,694

(22) Filed: Nov. 6, 2024

(30) Foreign Application Priority Data
Jun. 28, 2024 (CA) 3244735

(51) Int. Cl. E21B 43/26; B01D 5/00; B01D 53/62; E21B 41/00

(52) U.S. Cl. CPC E21B 43/2607; B01D 5/0006; B01D 5/009; E21B 41/0064; B01D 53/62; B01D 2257/80

(57) ABSTRACT

One process of the invention includes removing heat from a cooling medium and replenishing a frac water retention pond. The process includes exposing a hot exhaust gas stream to a chamber cooled by the cooling medium in a condensing portion of a carbon capture unit, condensing at least a portion of the hot exhaust gas stream in the condensing portion of the carbon capture unit to allow the condensation and removal of water vapour from the exhaust gas, thereby generating a water stream, wherein a water stream exits the carbon capture unit at an outlet thereof and the water stream move to the frac water retention pond. Another process includes using water to lower a temperature of a cooling medium in a hydraulic fracturing process step. Another process includes using condensed water from a post-combustion carbon capture unit to replenish a frac water source.

### FIELD OF THE INVENTION

The present invention is directed to a system for passive cooling of treated water, more specifically, a system for the passive cooling of treated water from shale oil production and compressor station operations, integrated with a post-combustion carbon capture unit, which provides make-up water for the system.

### BACKGROUND OF THE INVENTION

In the Montney region of northern British Columbia, treated water is used to fracture oil & gas reservoirs (“fracing”) to enable the production of natural gas. In some operations, the treated water (“frac water”) is recovered, stored in a retention pond and recycled, reducing the burden on local fresh water sources. These frac water retention ponds, which are typically found near the compressor station in a natural gas production facility, can serve a second purpose as a heat sink for cooling necessary for the compressor station at the production facility or for cooling for carbon capture units used to treat the compressor engine exhaust gases. The concept of using a liquid pool to cool a gas or liquid stream is well known and practiced in oil & gas production industry, but the use of a frac water retention pond for passive cooling for a compressor station or carbon capture unit is not obvious. Additionally, there still exists a need for an external source of water to maintain the water level of the frac water retention pond.

Some water is lost in the frac water retention pond during the fracing process and additional fresh water (“make-up”) is required to maintain the water recycling process. If a carbon capture unit is used to treat the exhaust gases from the compressor station, the carbon capture unit condenses water from the exhaust gases and this water can be used as make-up for the fracing operation.

Patent GB2553489 teaches a cooling system, including for use in cooling a product fluid such as a drilling fluid used in the drilling of a wellbore. The system comprises: a heat exchanger for heat exchange between a heat transfer medium and a drilling fluid; a cooling vessel in fluid communication with the heat exchanger to permit a heat transfer medium to be cycled therebetween; and a delivery arrangement comprising a plurality of delivery outlets for delivering a cooling medium into the cooling vessel to mix with and cool the heat transfer medium therein, at least two of the plurality of delivery outlets having different vertical positions within the cooling vessel.

Patent JP2014114981A teaches a static cooling system which can also be applied to an object to be cooled, required to be cooled at 100° C. or less and be maintained. The system comprises: a heat pipe of which one edge side is immersed in liquid of a heat removal object and the other end is immersed in cooling water of a cooling pool; coolant which is enclosed in the heat pipe and is boiled at 100° C. or less by heating; a vacuum generator which makes an inner part of the cooling pool vacuum by supplying gas; a cylinder in which gas to be supplied to the vacuum generator is enclosed; a supply pipeline which connects the cylinder with the vacuum generator; and, a supply opening and closing valve which is disposed on the supply pipeline and is driven by a manual electric source or electric source for emergency.

U.S. Pat. No. 5,596,877A teaches a cooling apparatus comprising a vessel confining a pool of liquid. A plurality of separate tubular passageways are immersed in the liquid. A single elongated header is provided which header has an inner and outer compartment. The inner compartment is operatively connected to one end of each of a plurality of tubular passageways. The outer compartment is operatively connected to the other end of each of a plurality of tubular passageways. An inlet manifold is connected to one of the inner or outer compartments of the header to supply refrigerant liquid to the plurality of passageways. An outlet manifold is connected to the other inner or outer compartment to receive the liquid refrigerant that has passed through the plurality of tubular passageways. There is no teaching about integrating of the described cooling apparatus with a shale production facility or a carbon capture unit.

U.S. Pat. No. 7,198,108B2 teaches an apparatus for cooling hot produced water from hydrocarbon processing or warming cold water resulting from heating liquified natural gas (LNG), such that the water is changed in temperature to be closer to that of the surrounding sea water. This patent teaches flowing a produced well fluid through a pipe that is immersed/exposed to water. However, in the invention disclosed in this patent, the produced well fluid is mixed with the sea water it is exposed to, and the resulting mixture is released into the sea.

In light of the existing prior art, there exists a need to optimize the energy consumption related to various processes directed at carbon capture and fracing. The present invention addresses the needs for both a source of cooling capacity and external make-up water, by using the synergies of shale oil production facility frac water retention ponds, which provide cooling capacity to cool exhaust gases from the production facility's operations, and the operation of an integrated carbon capture unit, which produces and directs condensed exhaust water vapour from the carbon capture unit to the frac water retention pond, reducing or eliminating the system's requirement for external make-up water.

### SUMMARY OF THE INVENTION

According to one aspect of the present invention, there is provided the use of pond water to lower the temperature of a cooling medium and to supply a hydraulic fracturing process step.

According to one aspect of the present invention, there is provided the use of condensed water from a post-combustion carbon capture unit to replenish a frac water source.

According to one aspect of the present invention, there is provided a process to remove heat from a cooling medium and replenish a frac water retention pond, such process comprising the following steps:
a. exposing a hot exhaust gas stream to a chamber cooled by said cooling medium in a condensing portion of a carbon capture unit;
b. condensing at least a portion of said hot exhaust gas stream in said condensing portion the carbon capture unit to allow the condensation and removal of the water vapour from the exhaust gas, thereby generating a water stream, said water stream exiting the carbon capture unit at an outlet thereof; and
c. discharging said water stream into said frac water retention pond.

According to a preferred embodiment of the present invention, there is provided a process wherein said cooling medium flows from said carbon capture unit to a floating or submerged moveable heat exchanger in said frac water retention pond, said moveable heat exchanger comprising:
a. at least one supply header pipe and at least one return header pipe;
b. at least one manifold connecting said at least one supply header pipe and said at least one return header pipe to one or more coils or bundles of tubing; and
c. at least one coil or bundle of tubing connected to said manifold wherein said at least one coil or bundle of tubing is adapted for immersion in said frac water retention pond.

In some preferred embodiments, said heated cooling medium is circulated through said moveable heat exchanger to cool the cooling medium to within 4-5° C. of a temperature of water inside said frac water retention pond, thereby generating a cooled cooling medium, said cooled cooling medium exiting the heat exchanger at an outlet thereof.

In some preferred embodiments, said cooled cooling medium is introduced to a condensing portion of said carbon capture unit.

In some preferred embodiments, a hot exhaust gas stream is introduced to said carbon capture unit, wherein said hot exhaust gas stream comprises water vapour.

In some preferred embodiments, said process is used to perform a hydraulic fracturing process using water from said frac water retention pond.

According to a preferred embodiment of the present invention, a compression unit of said shale gas production facility produces a hot exhaust gas stream which is sent to said carbon capture unit at an outlet thereof.

According to a preferred embodiment of the present invention, said heat exchanger tube material comprises: stainless steel, admiralty brass, aluminum or high heat conducting metals.

According to a preferred embodiment of the present invention, said heat exchanger tube material comprises: polyvinyl chloride (PVC), high density polyethylene (HDPE) or any functional plastic.

In some preferred embodiments, said cooling medium can be partially bypassed to modulate heat transfer in the cooling medium from changing operating or weather conditions.

In some preferred embodiments, said temperature of the hot exhaust gas stream is greater than 400° C.

### BRIEF DESCRIPTION OF THE FIGURES

The detailed description will be better understood in conjunction with the accompanying drawings as follows:

FIG. 1 illustrates a schematic of a preferred embodiment of the post-combustion carbon capture passive water cooling system integrated with shale gas production and natural gas compression;

FIG. 2 illustrates a top view of an arrangement of the pond cooler in the frac water retention pond, according to a preferred embodiment of the present invention; and

FIG. 3 illustrates a side view of an arrangement of the pond cooler in the frac water retention pond, according to a preferred embodiment of the present invention.

### DETAILED DESCRIPTION OF A PREFERRED EMBODIMENT

The description which follows and the embodiments described therein are provided by way of illustration of an example or examples of particular embodiments of the principles of the present invention. In the following description of the invention, examples are provided and specific details are set forth for the purposes of explanation and not limitation in order to provide a thorough understanding of the invention. Those that are skilled in the art will readily appreciate that the well-known methods, procedures and/or components will not be described as to focus on the invention in question. Accordingly, in some instances, certain structures and techniques have not been described or shown in detail in order not to obscure the invention.

According to a preferred embodiment of the present invention, a shale gas production unit 200 typically uses water and additives in the reservoir fracturing process with the water sometimes stored in a frac water retention pond 100 or in a storage vessel (not shown). The frac water retention pond 100 provides the ability to store and thus recycle water in the fracturing process, limiting the volume of fresh water required.

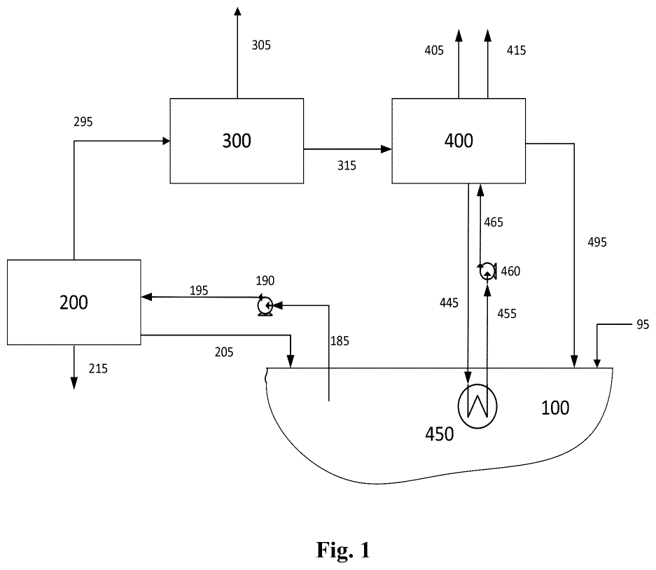

According to a preferred embodiment of the present invention and as shown in FIG. 1, the water from the frac water retention pond 100 is removed in stream 185 via pump 190, through steam 195, to a shale production unit 200. Most to all of the frac water is returned to the retention pond via stream 205. Any frac water that remains in the reservoir is shown as stream 215. Make-up water to replace frac water lost in shale production unit 200 is provided from local sources through stream 95 but can be reduced between 10-90% with the supply of condensed water in stream 495 from a carbon capture unit 400.

The natural gas produced from the shale gas production unit 200 is sent to a compressor station unit 300 via stream 295. The natural gas is compressed up to pressures above 5,000 kpag typically for transport via stream 305 to further processing facilities to prepare for sales to customers.

The hot exhaust gas generated in the compressor station unit 300, typically from natural gas driven compressor engines, is sent via stream 315 to the carbon capture unit 400. CO₂ is separated from the exhaust gas stream and concentrated up to over 95% purity and sent to a further stage of CO₂ processing via stream 405. The next stage of CO₂ processing may be compression for transport for sequestration or conversion units for utilization as a petrochemical feedstock. The depleted exhaust gas (after removal of CO₂ and water vapour) is safely vented to the atmosphere via stream 415.

The carbon capture unit 400 takes hot exhaust gas (over 400° C.) from the compressor station unit 300 engines via stream 315, which needs to be cooled before being processed. In addition, the operation of the carbon capture unit 400 requires further cooling. Normally, fin-fan air coolers, which require power and a large footprint, are used to provide the necessary cooling for the carbon capture unit 400. Typically in remote locations, the power required for the fin-fan air coolers comes from fossil fuel-based (natural gas and/or diesel) power generators which adds to the CO₂ to be captured at the compressor station unit 300, thereby also increasing the required size of the carbon capture unit 400. To avoid the additional power needed by, and CO₂ generated from, the use of fin-fan coolers, a moveable heat exchanger 450 is immersed in to the frac water retention pond 100. The frac water retention pond 100 acts as an indirect-contact heat sink for the hot cooling medium in stream 445 from the carbon capture unit 400. The cooling medium in stream 445 is cooled to within 4-5° C. of the retention pond 100 water and leaves the moveable heat exchanger 450 as stream 455. The resulting cooled cooling medium is pumped through pump 460 back to the carbon capture unit 400 via stream 465. The hot exhaust gas stream 315 is exposed to a chamber (not shown) cooled by said cooled cooling medium in a condensing portion of a carbon capture unit 400. At least a portion of said hot exhaust gas stream 315 is condensed in said condensing portion the carbon capture unit 400 to allow the condensation and removal of the water vapour from the exhaust gas, thereby generating a condensed water stream 495, which exits the carbon capture unit 400 and is discharged into the frac water retention pond 100. The condensed water stream 495 also serves to offset any evaporation generated in the frac water retention pond 100 from the increase in temperature for the moveable heat exchanger 450. The excess condensed water may offset the amount of make-up water needed.

The cooling medium is selected from the group consisting of: water, ethylene glycol, any other heat transfer fluid or a combination of one or more fluids.

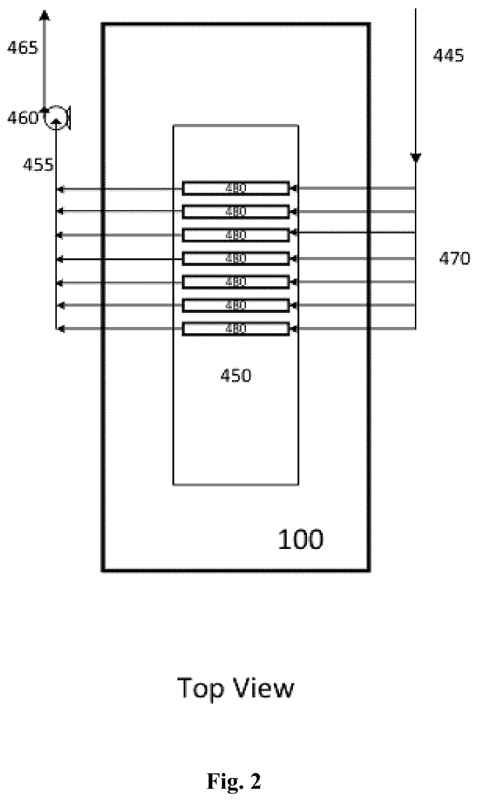

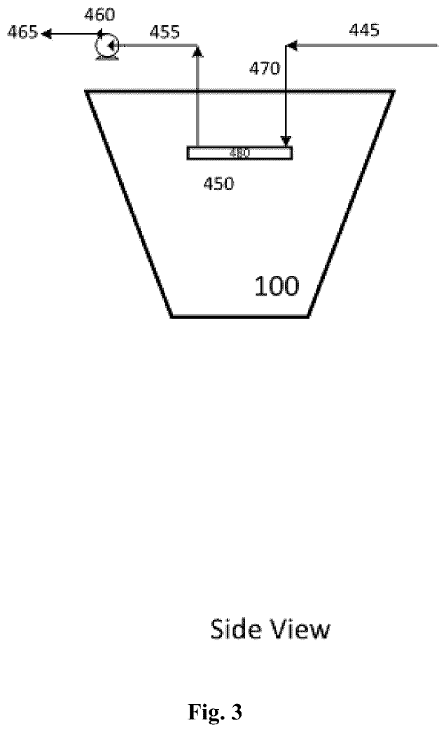

According to a preferred embodiment of the present invention, the moveable heat exchanger 450 can be a series of tubes made of plastic or metal for better heat transfer but higher cost. Some plastics are PVC, HDPE, PFTE while some metals can be aluminum, admiral brass, and various grades of stainless steel. The moveable heat exchanger 450 can also be in the form of a plate and frame, spiral or shell and tube style. A preferred layout of the heat exchanger 450 is shown in FIGS. 2 and 3 with tubes 480 laid across the retention pond 100 with water distributed via a manifold 470. The tubes 480 can be submerged for maximum heat transfer with submersion at a range of depths, preferably between 1 m and 6 m from the surface. The water in tubes 480 leaves the frac water retention pond 100 in stream 455 and is pumped through pump 460 back to the process via stream 465.

For a representative amine-based, 200 tons per day carbon capture unit with compression on post-combustion exhaust, approximately 500 KW of cooling is needed in the summer months of northeastern British Columbia. A preferred embodiment of the present invention situated within the frac water retention pond at such a facility can provide the entire 500 KW of cooling, thereby removing the need for air cooling.

The examples and corresponding diagrams used herein are for illustrative purposes only. The principles discussed herein can be implemented in other systems and apparatuses. Different configurations and terminology can be used without departing from the principles expressed herein. For instance, steps, equipment, components, and modules can be added, deleted, modified, or re-arranged without departing from these principles.

Unless the context clearly requires otherwise, throughout the description and the claims:
“comprise,” “comprising,” and the like are to be construed in an inclusive sense, as opposed to an exclusive or exhaustive sense; that is to say, in the sense of “including, but not limited to”. “Herein,” “above,” “below,” and words of similar import, when used to describe this specification shall refer to this specification as a whole and not to any particular portions of this specification. “Or” in reference to a list of two or more items, covers all of the following interpretations of the word: any of the items in the list, all of the items in the list, and any combination of the items in the list. The singular forms “a”, “an”, and “the” also include the meaning of any appropriate plural forms.

Where a component is referred to above, unless otherwise indicated, reference to that component should be interpreted as including as equivalents of that component, any component which performs the function of the described component (i.e., that is functionally equivalent), including components which are not structurally or compositionally equivalent to the disclosed structure or composition which performs the function in the illustrated exemplary implementations of the invention.

Specific examples of compositions, systems, methods and apparatuses have been described herein for purposes of illustration. These are only examples. Many alterations, modifications, additions, omissions and permutations are possible within the practice of this invention. This invention includes variations on described compositions, processes or uses that would be apparent to the skilled addressee, including variations obtained by: replacing features or elements with equivalent features or elements; mixing and matching of features or elements from different examples; combining features or elements from examples as described herein with features or elements of other technology; omitting or combining features or elements from described examples.

It is therefore intended that the following appended claims and claims hereafter introduced are interpreted to include all such modifications, permutations, additions, omissions and sub-combinations as may reasonably be inferred. The scope of the claims should not be limited by the preferred embodiments set forth in the examples, but should be given the broadest interpretation consistent with the description as a whole.

1. A process applied to hydraulic fracturing comprising:
using water to lower a temperature of a cooling medium in a hydraulic fracturing process step.

2. The process according to claim 1 wherein the water is contained in a pond or vessel.

3. A process applied to hydraulic fracturing comprising:
using condensed water from a post-combustion carbon capture unit to replenish a frac water source.

4. A process to remove heat from a cooling medium and replenish a frac water retention pond, such process comprising the following steps:
i. exposing a hot exhaust gas stream to a chamber cooled by said cooling medium in a condensing portion of a carbon capture unit;
ii. condensing at least a portion of said hot exhaust gas stream in said condensing portion the carbon capture unit to allow the condensation and removal the water vapour from the exhaust gas, thereby generating a water stream, said water stream exiting the carbon capture unit at an outlet thereof; and
iii. discharging said water stream into said frac water retention pond.

5. The process according to claim 4 wherein said cooling medium flows from said carbon capture unit to a floating or submerged moveable heat exchanger in said frac water retention pond, said moveable heat exchanger comprising:
i. at least one supply header pipe and at least one return header pipe;
ii. at least one manifold connecting said at least one supply header pipe and
said at least one return header pipe to one or more coils or bundles of tubing; and
iii. at least one coil or bundle of tubing connected to said manifold, wherein said at least one coil or bundle of tubing is adapted for immersion in said frac water retention pond.

6. The process according to claim 5 wherein said heated cooling medium is circulated through said moveable heat exchanger to cool the cooling medium to within at least 5° C. of a temperature of a liquid present in said frac water retention pond, thereby generating a cooled cooling medium, said cooled cooling medium exiting the heat exchanger at an outlet thereof.

7. The process according to claim 6 wherein said cooled cooling medium is introduced to a condensing portion of said carbon capture unit.

8. The process according to claim 7 wherein a hot exhaust gas stream is introduced to said carbon capture unit, wherein said hot exhaust gas stream comprises water vapour.

9. The process according to claim 4 wherein said process is used to perform a hydraulic fracturing process using water from said frac water retention pond.

10. The process according to claim 9 wherein a compression unit of said shale gas production facility produces a hot exhaust gas stream which is sent to said carbon capture unit at an outlet thereof.

11. The process as claimed in claim 5, wherein the heat exchanger tube material comprises: stainless steel, admiralty brass, aluminum or high heat conducting metals.

12. The process as claimed in claim 5, wherein the heat exchanger tube material comprises: polyvinyl chloride (PVC), high density polyethylene (HDPE) or any functional plastic.

13. The process as claimed in claim 5 wherein the cooling medium can be partially bypassed to modulate heat transfer in the cooling medium from changing operating or weather conditions.

14. The process as claimed in claim 5 wherein the temperature of the hot exhaust gas stream is greater than 400° C.
